(19) United States
(12) Patent Application Publication
(10) Pub. No.: US 2006/0266414 A1
(43) Pub. Date: Nov. 30, 2006

(54) Changeover valve

(75) Inventors: Michael Baraga, Stuttgart (DE); Tobias Goedecke, Kernen (DE)

Correspondence Address: CROWELL & MORING LLP;INTELLECTUAL PROPERTY GROUP, P.O. BOX 14300, WASHINGTON, DC, 20044-4300, US

(73) Assignee: DAIMLERCHRYSLER AG, Stuttgart (DE)

(21) Appl. No.: 10/564,400

(22) PCT Filed: Jul. 15, 2004
(86) PCT No.: PCT/EP04/07843

§ 371 Date: Jun. 12, 2006

(30) Foreign Application Priority Data
Jul. 16, 2003 (DE) 103 32 209.4

(51) Int. Cl. G05D 11/00

(52) U.S. Cl. 137/112

(57) ABSTRACT

The invention proceeds from a changeover valve, in particular for an automatic transmission of a motor vehicle, having at least one closing means (11) which is arranged in a housing part (10) and which, in order to control a flow, can be guided into at least two valve seats (16, 17) and is arranged in a control duct (20) which is open exclusively toward a connection side (15) of the housing part (10).

It is proposed that in a switched-off state, considered in an operating configuration, the closing means (11) adopts a defined initial control position (18).

This invention relates to a changeover valve.

Changeover valves for automatic transmissions having a closing means arranged in a housing part and formed by a valve ball are known. In order to control a flow in three ducts which adjoin one side of the housing part, the valve ball can be guided into a first valve seat and a second valve seat.

The valve ball is arranged in a trough-shaped control duct which is open exclusively toward a connection side of the housing part. In a first control position, the valve ball bears against the first valve seat which is inserted in an intermediate metal plate which covers the trough-shaped control duct. In a second control position, the valve ball bears against the second valve seat which is inserted in the intermediate metal plate. In the event of a switch from the first control position into the second control position, considered in an operating configuration, the valve ball firstly moves vertically downward out of the first valve seat, thereafter moving horizontally in the longitudinal direction of the trough-shaped control duct and subsequently moving vertically upward into the second valve seat. In the event of a switch from the second control position into the first control position, the sequence of movements of the valve ball is correspondingly reversed.

If the changeover valve is switched off, the valve ball comes to rest on a base of the trough-shaped control duct in an undefined position between the valve seats.

It is in particular the object of the invention to provide a generic changeover valve which has reduced wear and whose switching operation time lag is reduced overall. This object is achieved according to the invention, and various embodiments are defined by the dependent claims.

The invention concerns a changeover valve, in particular for an automatic transmission of a motor vehicle, having at least one closing means which is arranged in a housing part and which, in order to control a flow, can be guided into at least two valve seats and is arranged in a control duct which is open exclusively toward a connection side of the housing part.

It is proposed that in a switched-off state, considered in an operating configuration, the closing means adopts a defined initial control position. The defined initial control position can advantageously be assigned a preferred switching position. Movement of the closing means, wear resulting therefrom and time lags can be avoided, and movement of the closing means can be avoided in particular if the changeover valve is operated in the preferred switching position starting from its switched-off state. In the case of automatic transmissions in particular, increased comfort can be achieved as a result in shift and control processes. In addition, a defined rebound position can be achieved, in particular if the initial control position corresponds to the rebound position. In this context, the operating configuration is to be understood as the basic spatial arrangement of the changeover valve in the assembled state.

If the defined initial position, considered in the operating configuration, lies below a second control position of the closing means, and if, in the switched-off position, the closing means is held at least partially and preferably completely in the defined initial control position under the force of gravity, a further element which leads the closing means into its initial control position, such as a spring element, can at least be designed in a space-saving and cost-effective manner or even, as is particularly preferable, eliminated completely.

In this case, the control duct advantageously has, considered in the operating configuration, at least one angle to the horizontal, and in its defined initial control position, the closing means bears against a lower valve seat in the control duct, as a result of which the control duct can be manufactured in a particularly simple, cost-effective and space-saving manner, in particular if the latter is formed to be at least substantially perpendicular to a face of the connection side of the housing part.

It is also proposed that in a second control position, considered in an operating configuration, the closing means bears against an upper valve seat in the control duct. An advantageously at least predominantly linear movement of the closing means between the initial control position and the second control position can be achieved, to be specific in particular if the control duct is of linear design, and wear caused by changes in direction can be avoided.

If the housing part has at least one second duct in addition to the control duct, and if the control duct and the second duct are connected by means of a transverse duct in the housing part, a changeover valve having a closing means which has a defined initial control position and a low number of components can be obtained in a particularly simple structural manner.

The ducts can basically be manufactured by means of various manufacturing processes which would seem sensible to the person skilled in the art, it being possible to form said ducts in the housing part by means of primary forming, forming and/or by means of a cutting process, such as milling, boring etc. If the transverse duct is formed by a bore, this can be simply formed in a particularly space-saving manner.

It is also proposed that the transverse duct is sealed off outwardly by a metal closing plate. A plurality of sealing functions can be advantageously imposed in a simple manner on the metal closing plate and components can be saved overall. The transverse duct could basically however also be closed off by other closing means which would seem appropriate to the person skilled in the art, such as a sealing screw, a pressed-in ball etc.

If the closing means is formed by a valve ball, this can be of particularly cost-effective design, good sealing properties can be achieved in a structurally simple manner and simple installation of the valve ball can be achieved. Other closing means are however also basically conceivable, such as piston-shaped closing means.

Further advantages are disclosed in the following description of the drawing. One exemplary embodiment of the invention is illustrated in the drawing. The description and the claims contain many features in combination. A person skilled in the art will expediently also consider the features individually and combine them to form further meaningful combinations.

### BRIEF DESCRIPTION OF THE DRAWINGS

FIG. 1 shows a detail of a changeover valve according to the invention having a closing means in an initial control position,

FIG. 2 shows the changeover valve of FIG. 1 having the closing means in a second control position, and

FIG. 3 shows the changeover valve of FIG. 1 in a rebound position.

### DETAILED DESCRIPTION OF THE INVENTION

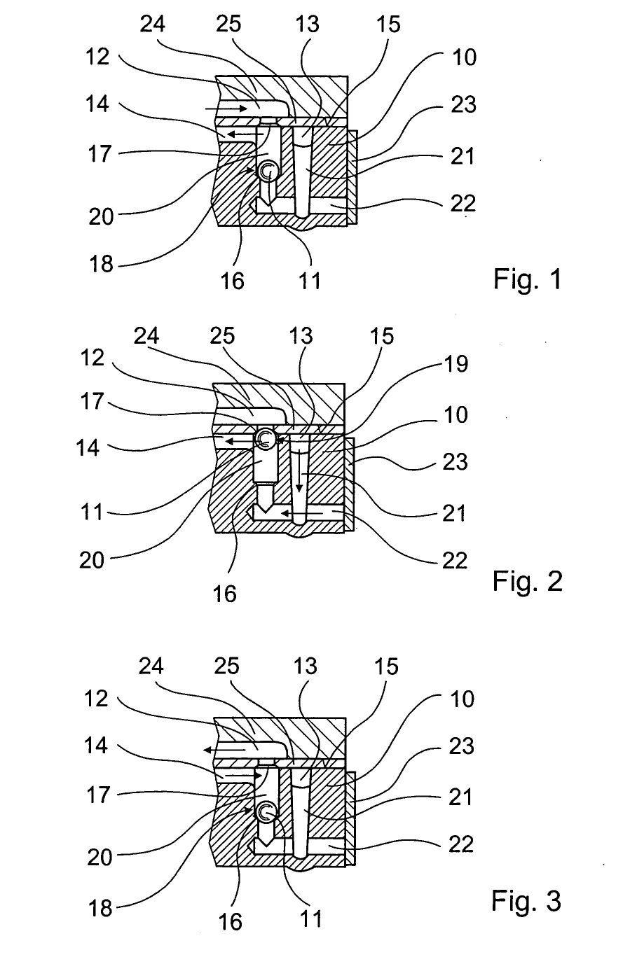

FIG. 1 illustrates a changeover valve for an automatic transmission of a motor vehicle. The changeover valve has a first housing part 10 formed by a control plate, and a second housing part 24 formed by a transmission housing part. An intermediate metal plate 25 is arranged between the housing parts 10, 24.

The following description relates to an operating configuration of the changeover valve, that is to say to a basic spatial arrangement of the changeover valve in the assembled state on a motor vehicle situated on a horizontally aligned plane. In the first housing part 10, a closing means 11 designed as a valve ball is arranged in a vertically extending linear control duct 20 which is manufactured by means of a bore. The control duct 20 is designed to be open exclusively toward a connection side 15 of the first housing part 10, as a result of which the changeover valve can advantageously be designed to have a two-part housing. The closing means 11 serves to control a flow in three ducts 12, 13, 14 which adjoin the connection side 15 of the first housing part 10 and for this purpose can be guided into two valve seats 16, 17, the control duct 20 being perpendicular to the connection side 15. The ducts 12 and 13 are connected to a supply device and the duct 14 is connected to an actuator. Other allocations would however also be basically possible.

In addition to the control duct 20, the first housing part 10 has a second duct 21 which runs parallel to the control duct 20 and is cast on to the first housing part 10. The control duct 20 and the second duct 21 are connected by means of a transverse duct 22 which runs horizontally in the first housing part 10 and is manufactured by means of a blind bore. The ducts 12, 14, 20, 21, 22 all lie in one plane. The horizontally running transverse duct 22 is outwardly closed off by means of a metal closing plate 23 which, in addition to the sealing function with regard to the transverse duct 22, carries out further sealing functions of the changeover valve.

In a switched-off state, the closing means 11 assumes a defined initial control position 18 and in this case bears against the lower valve seat 16 which is integrally formed on the control duct 20 (FIG. 1). In the switched-off state, the closing means 11 is held in the defined initial control position 18 under the force of gravity. The initial control position 18 is assigned a preferred switching position in which a hydraulic pressure medium can flow from the duct 12, via the control duct 20 and via the duct 14 to the actuator which is not illustrated in more detail. The ducts 12, 14 are sealed off from the duct 13 by the closing means 11.

In a second control position 19, the closing means 11 bears against the valve seat 17 which is an upper one or is arranged directly above the initial control position 18 and integrally formed on the intermediate metal plate 25, in the control duct 20 FIG. 2). In the second control position 19, the pressure medium can flow from the duct 13, which runs perpendicular to the drawing plane in the illustration, via the duct 21, the transverse duct 22, the control duct 20 and via the duct 14 to the actuator. The ducts 13, 21, 22, 20, 14 are sealed off from the duct 12 by the closing means 11.

FIG. 3 shows the changeover valve having the closing means in a rebound position which corresponds to the initial control position 18. In the rebound position, the pressure medium can flow back from the actuator via the duct 14, the control duct 20 and via the duct 12.

The ducts 12, 14 are sealed off from the duct 13 by the closing means 11.

1-11. (canceled)

12. A changeover valve for an automatic transmission of a motor vehicle, comprising:
a control plate,
at least two valve seats, and
at least one closing means which is arranged in the control plate, which, in order to control a flow, can be guided into the least two valve seats, and which is arranged in a control duct that is open exclusively toward a planar connection side of the control plate,
wherein in an operating configuration, in a switched-off state, the closing means adopts a defined initial control position, and
wherein the closing means serves to control the flow in at least three ducts which adjoin the planar connection side of the control plate.

13. The changeover valve according to claim 12, wherein the defined initial position, considered in the operating configuration, lies below a second control position of the closing means, and wherein, in the switched-off state, the closing means is held at least partially in the defined initial control position under the force of gravity.

14. The changeover valve according to claim 13, wherein, in the operating configuration, the control duct has at least one angle to the horizontal, and wherein, in its defined initial control position, the closing means bears against a lower valve seat in the control duct.

15. The changeover valve according to claim 14, wherein, in the operating configuration, in the second control position, the closing means bears against an upper valve seat in the control duct.

16. The changeover valve according to claim 14, wherein the control plate has at least one second duct in addition to the control duct, and wherein the control duct and the second duct are connected by a transverse duct in the control plate.

17. The changeover valve according to claim 16, wherein the transverse duct is formed by a bore.

18. The changeover valve according to claim 16, wherein the transverse duct is outwardly sealed off by a metal closing plate.

19. The changeover valve according to claim 12, wherein the defined initial control position corresponds to a rebound position.

20. The changeover valve according to claim 12, wherein the closing means is formed by a valve ball.

21. The changeover valve according to claim 12, wherein at least one of the valve seats is integrally formed on the control plate.

22. The changeover valve according to claim 15, wherein the control plate has at least one second duct in addition to the control duct, and wherein the control duct and the second duct are connected by a transverse duct in the control plate.

23. The changeover valve according to claim 22, wherein the transverse duct is formed by a bore.

24. The changeover valve according to claim 17, wherein the transverse duct is outwardly sealed off by a metal closing plate.

25. The changeover valve according to claim 13, wherein the defined initial control position corresponds to a rebound position.

26. The changeover valve according to claim 14, wherein the defined initial control position corresponds to a rebound position.

27. The changeover valve according to claim 15, wherein the defined initial control position corresponds to a rebound position.

28. The changeover valve according to claim 13, wherein the closing means is formed by a valve ball.

29. The changeover valve according to claim 13, wherein at least one of the valve seats is integrally formed on the control plate.

30. The changeover valve according to claim 14, wherein at least one of the valve seats is integrally formed on the control plate.

31. A transmission control unit having at least one changeover valve as claimed in claim 12.
